(19) United States
(12) Patent Application Publication
(10) Pub. No.: US 2025/0324454 A1
(43) Pub. Date: Oct. 16, 2025

(54) DEFER SIGNAL FOR CHANNEL ACCESS PREEMPTION IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US)

(21) Appl. No.: 19/091,663

(22) Filed: Mar. 26, 2025

Related U.S. Application Data
(60) Provisional application No. 63/632,873, filed on Apr. 11, 2024.

(51) Int. Cl. H04W 74/0816; H04W 74/08

(52) U.S. Cl. CPC H04W 74/0816; H04W 74/0875

(57) ABSTRACT

An embodiment includes a STA with low latency traffic may transmit a defer signal to preempt one or more others STAs from contending for channel access, whereby the STA may quickly obtain channel access to transmit low latency frames, whereby the defer signal may place the one or more other STAs in an extended interframe space (EIFS) state or in an error state.

### CROSS-REFERENCE TO RELATED APPLICATION(S)

This application claims the benefit of priority from U.S. Provisional Application No. 63/632,873, entitled “Defer Signal Design for Channel Access Preemption in Next Generation WLANS” filed Apr. 11, 2024, which is incorporated herein by reference in its entirety.

### TECHNICAL FIELD

This disclosure relates generally to a wireless communication system, and more particularly to, for example, but not limited to, channel access preemption using defer signals in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising: a memory; and a processor coupled to the memory. The processor is configured to determine that the STA has low-latency traffic to be transmitted. The processor is configured to transmit a defer signal to block one or more STAs from contending for a channel for a period of time. The processor is configured to contend for the channel and obtain access to the channel during the period of time. The processor is configured to transmit, to an access point (AP), the low-latency traffic via the channel.

In some embodiments, the defer signal is transmitted at a pre-determined time that is associated with at least one of an interframe spacing (IFS) start time boundary, an IFS end time boundary, a service period start time, a service period end time, or a time boundary marked by periodic frames.

In some embodiments, the processor is further configured to: determine that the channel is idle; and transmit another defer signal based on the determination that the channel is idle.

In some embodiments, the processor is further configured to use a prioritized enhanced distributed channel access (EDCA) parameter set that prioritizes transmission of the low-latency traffic.

In some embodiments, the defer signal causes the one or more legacy STAS to: abstain from contending the channel access for a period of time; enter an extended interframe space (EIFS) state for the period of time; or update a network allocation vector (NAV) timer for the period of time.

In some embodiments, the defer signal is a frame transmitted to the one or more STAs for which a frame check sequence value of the frame is incorrect.

In some embodiments, the defer signal is a frame and a modulation of the frame determines a duration for which the one or more STAs are blocked from contending for the channel.

In some embodiments, the processor is further configured to transmit, during a pre-determined interframe spacing gap, another defer signal.

One aspect of the present disclosure provides an access point (AP) in a wireless network, the AP comprising: a memory; and a processor coupled to the memory. The processor is configured to determine that a station (STA) has low-latency traffic to be transmitted. The processor is configured to transmit a defer signal to block one or more STAs from contending for a channel for a period of time. The processor is configured to receive, from the STA, the low-latency traffic via the channel.

In some embodiments, the defer signal is transmitted at a pre-determined time that is associated with at least one of an interframe spacing (IFS) start time boundary, an IFS end time boundary, a service period start time, a service period end time, or a time boundary marked by periodic frames.

In some embodiments, the processor is further configured to: determine that the channel is idle; and transmit another defer signal based on the determination that the channel is idle.

In some embodiments, the defer signal causes the one or more STAS to: abstain from contending the channel access for a period of time; enter an extended interframe space (EIFS) state for the period of time; or update a network allocation vector (NAV) timer for the period of time.

In some embodiments, the defer signal is a frame transmitted to the one or more STAs for which a frame check sequence value of the frame is incorrect.

In some embodiments, the defer signal is a frame and a modulation of the frame determines a duration for which the one or more STAs are blocked from contending for the channel.

One aspect of the present disclosure provides a computer-implemented method for wireless communication by a station (STA) in a wireless network. The method comprises determining that the STA has low-latency traffic to be transmitted. The method comprises transmitting a defer signal to block one or more STAs from contending for a channel for a period of time. The method comprises contending for the channel and obtain access to the channel during the period of time. The method comprises transmitting, to an access point (AP), the low-latency traffic via the channel.

In some embodiments, the defer signal is transmitted at a pre-determined time that is associated with at least one of an interframe spacing (IFS) start time boundary, an IFS end time boundary, a service period start time, a service period end time, or a time boundary marked by periodic frames.

In some embodiments, the method further comprises determining that the channel is idle; and transmitting another defer signal based on the determination that the channel is idle.

In some embodiments, the method further comprises using a prioritized enhanced distributed channel access (EDCA) parameter set that prioritizes transmission of the low-latency traffic.

In some embodiments, the defer signal causes the one or more STAS to: abstain from contending the channel access for a period of time; enter an extended interframe space (EIFS) state for the period of time; or update a network allocation vector (NAV) timer for the period of time.

In some embodiments, the defer signal is a frame transmitted to the one or more STAs for which a frame check sequence value of the frame is incorrect.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a flow chart of an example process by a STA of transmitting a defer signal at a time boundary in accordance with an embodiment.

FIG. 5 illustrates an example of a service period time boundary for defer signal transmission in accordance with an embodiment.

FIG. 6 illustrates another example of a service period time boundary for defer signal transmission in accordance with an embodiment.

FIG. 7 illustrates an interframe spacing boundary for defer signal transmission in accordance with an embodiment.

FIG. 8 illustrates a flow chart of an example process by an AP for defer signal transmission in accordance with an embodiment.

FIG. 9 illustrates an example of a defer signal transmission by an AP in accordance with an embodiment.

FIG. 10 illustrates a flow chart of an example process by a STA for transmitting a defer signal when a channel is idle in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

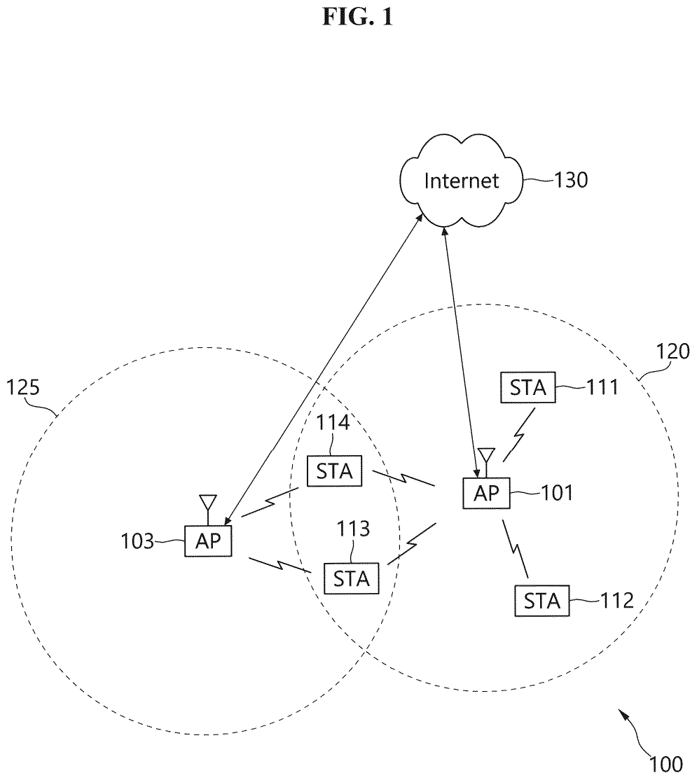

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

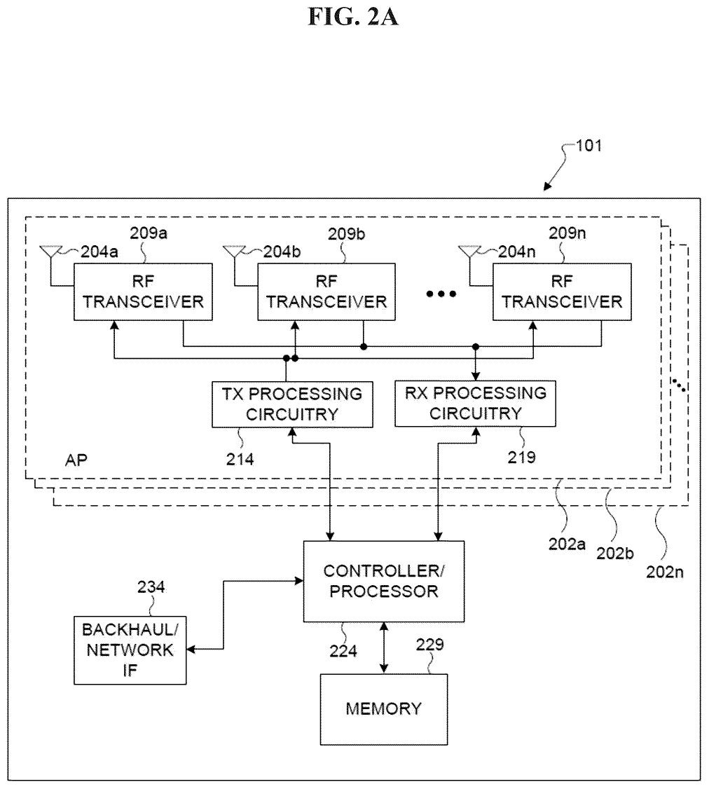

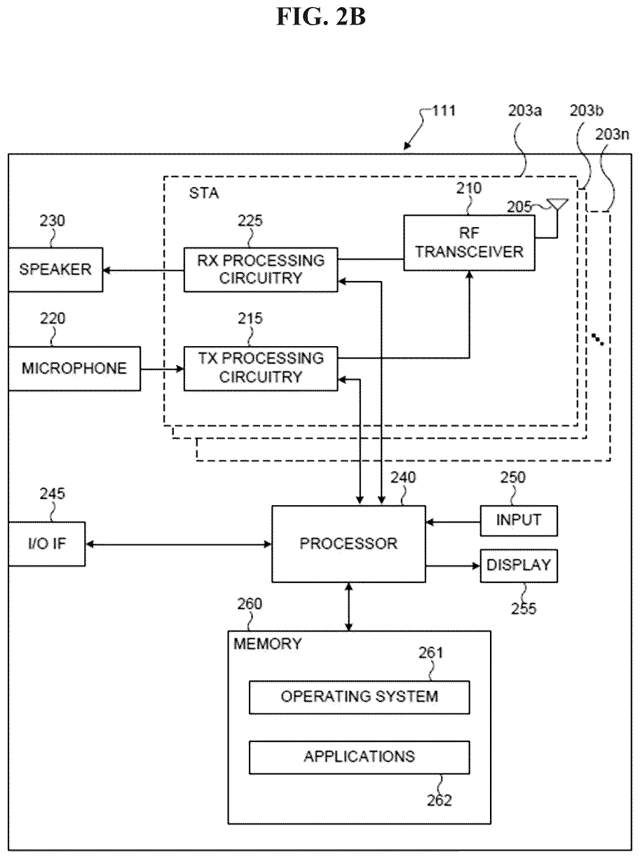

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

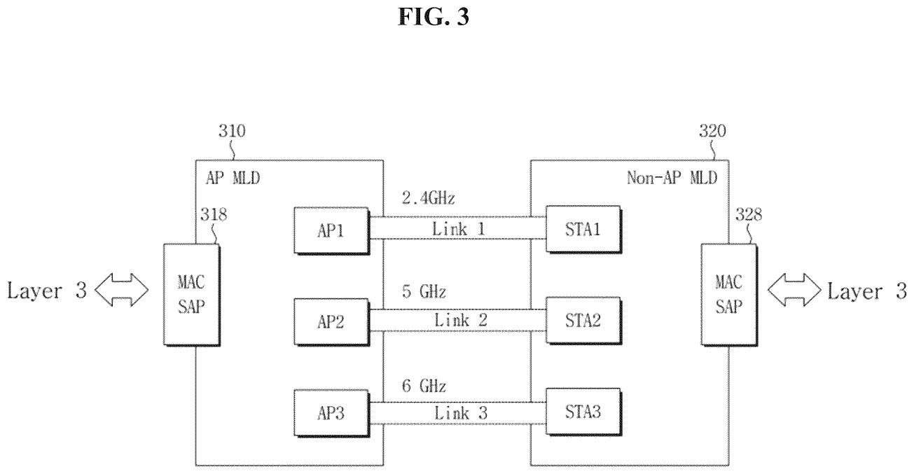

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

A bottleneck in wireless networks may be a channel access delay that a device encounters when attempting to transmit data. A channel access delay may increase based on various factors including a number of users in the network, a user's traffic load, data rates, among other factors. To support applications with low latency (LL) requirements, features that can reduce the time to access the channel may be beneficial. The next generation of WLAN may incorporate the concept of preemption to prioritize LL traffic. In some embodiments, the preemption serves as a mechanism to stop current ongoing transmissions and initiate a LL traffic transmission, ensuring that a delay bound for the LL traffic is met in time. Accordingly, embodiments in accordance with this disclosure may allow devices with LL applications, which may herein be referred to as LL STAs, to perform Enhanced Distributed Channel Access (EDCA) preemption. During EDCA preemption, the devices can capture the channel before legacy devices and transmit their frames thereby avoiding the channel access delays faced by legacy channel access mechanisms (which may be referred to herein as legacy channel access delay). In some embodiments, EDCA preemption may include transmitting a signal which can prevent legacy devices from accessing the medium for a certain period of time, which may be referred to herein as defer signal. The devices with low latency applications can then contend for channel access in this period of time and avoid enduring the legacy channel access delay. Embodiments in accordance with this disclosure provide a defer signal which can be transmitted to enable EDCA preemption.

In some embodiments, the defer signal can be transmitted at a known time boundary. A known time boundary may refer to a time boundary that one or more STAs (e.g., all STAs) are aware of. By using a known time boundary, the STA can avoid the overhead of channel access for defer signal transmission. As described herein, a known time boundary can be one or more of the boundaries listed in Table 1.

Table 1 provides a list of time boundaries that can be used for transmitting the defer signal in accordance with an embodiment.

TABLE 1

| Time boundary | Description |
|---|---|
| Interframe spacing | The defer signal can be transmitted at an interframe spacing (IFS) time |
| end time boundary | boundary. The IFS time boundary can be an existing IFS (e.g., |
| | Distributed Coordination Function (DCF) interframe spacing (DIFS)) |
| | or a newly defined IFS. |
| Interframe spacing | The defer signal can be transmitted at the start time of an interframe |
| start time | spacing. e.g., start time boundary of short interframe spacing (SIFS), |
| boundary | Point Coordination Function (PCF) interframe spacing (PIFS), among |
| | others. |
| Service period | The start time of a service period. e.g., service period of target-wake- |
| start time | time (TWT) or its variants. |
| Service period end | The end time of a service period. e.g., end time of service periods of |
| time | TWT or its variants. |
| Time boundaries | A time boundary that is marked by periodic frames. e.g., management |
| marked by | frames. For instance, there can be a time boundary following a beacon |
| periodic frames | transmission. |

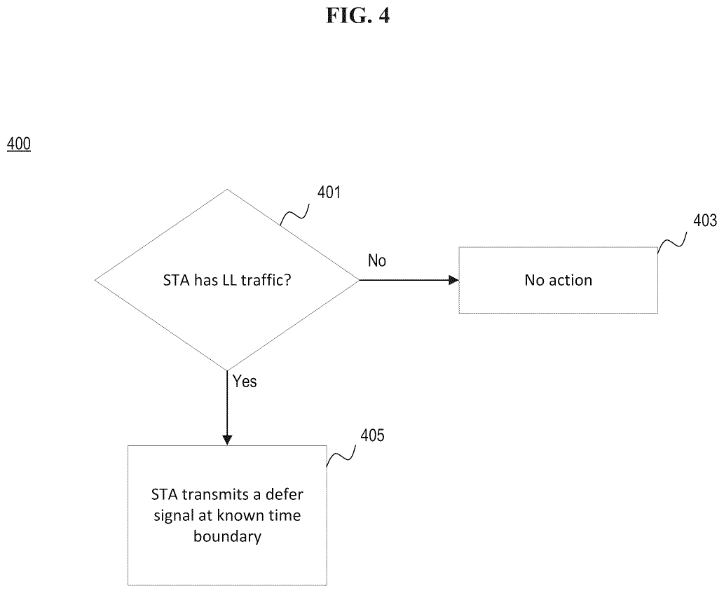

FIG. 4 illustrates a flow chart of an example process by a STA of transmitting a defer signal at a known time boundary in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 4 illustrates operations performed in a STA, such as the STA illustrated in FIG. 3.

In operation 401, the STA determines whether the STA has low latency traffic. In some embodiments, low latency traffic may include traffic of frames whose delay tolerance is less than an STA's channel access delay for the wireless medium. If the STA determines that it does not have LL traffic, the process proceeds to operation 403 and the STA performs no action. If the STA determines that it does have LL traffic, the process proceeds to operation 405.

In operation 405, the STA transmits a defer signal at a known time boundary. In some embodiments, the defer signal can be such that it can put legacy devices into a mode of operation where they may not perform channel access (e.g., extended interframe spacing (EIFS) state). In some embodiments, a defer signal can be designed such that it can cause the PHY-RXEND.indication primitive to include an error or a frame for which the frame check sequence (FCS) value is incorrect. After transmitting the defer signal, the STA may then contend for the channel.

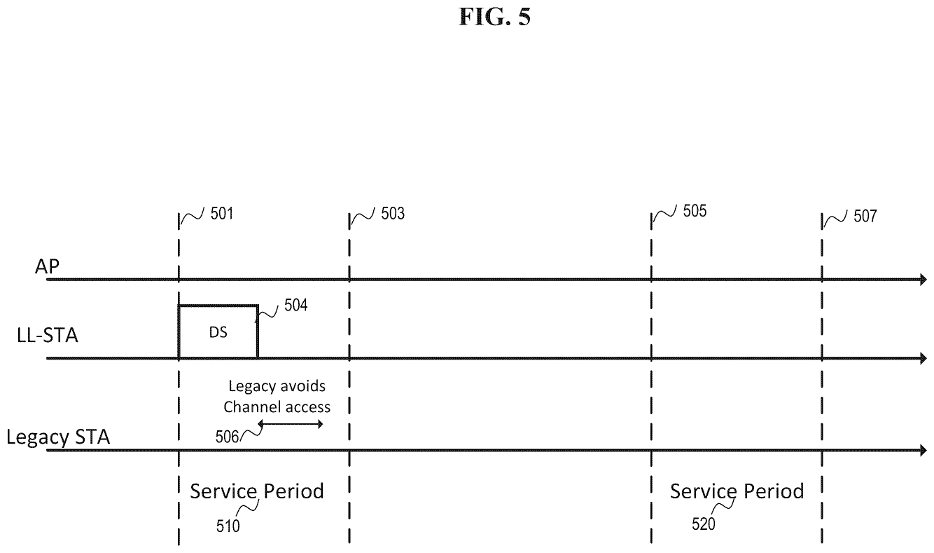

FIG. 5 illustrates an example of a service period time boundary for defer signal transmission in accordance with an embodiment. In particular, FIG. 5 illustrates communication among an AP, an LL STA, and a legacy STA. FIG. 5 illustrates two service period durations 510 and 520, each of which include a service period start time boundary and a service period end time boundary. In some embodiments, the service period may refer to a negotiated time interval between the AP and the one or more STAs (e.g., LL STA and legacy STA) during which data packets can be exchanged. As illustrated, the first service period 510 includes a service period start time boundary 501 and a service period end time boundary 503. The second service period 520 includes a service period start time boundary 505 and a service period end time boundary 507. These time boundaries may be known by the AP, the LL STA and the legacy STA.

At the service period start time boundary 501 of the first service period 510, the LL STA transmits a defer signal 504. In particular, the defer signal is transmitted at a known time boundary 501 that is known by the AP, the LL-STA, and the legacy STA. Accordingly, the legacy STA avoids channel access for a duration of time 506 after the defer signal 503. In some embodiments, the defer signal's modulation can be used to control the duration for which the legacy STA can avoid channel access. As illustrated, the duration of time 506 ends shortly before the service period end time boundary 503.

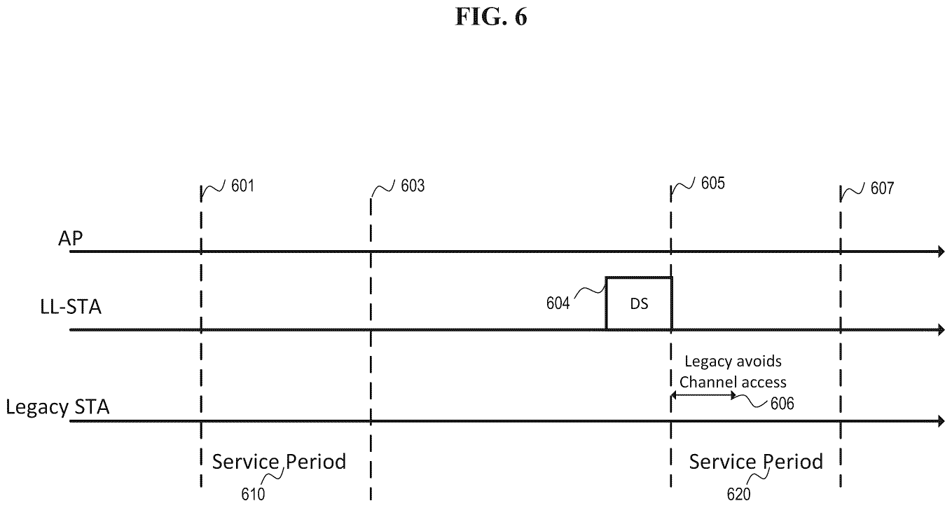

FIG. 6 illustrates another example of a service period time boundary for defer signal transmission in accordance with an embodiment. In particular, FIG. 6 illustrates communication among an AP, a LL STA, and a legacy STA. Similar to FIG. 5, FIG. 6 illustrates two service period durations 610 and 620, each of which includes a service period start time boundary and a service period end time boundary. As illustrated, the first service period 610 includes a service period start time boundary 601 and a service period end time boundary 603. The second service period 620 includes a service period start time boundary 605 and a service period end time boundary 607. These time boundaries may be known by the AP, the LL STA and the legacy STA.

As illustrated, the LL STA transmits a defer signal 601 immediately before the service period time boundary 605 of the second service period 620. Accordingly, the legacy STA avoids channel access for a duration of time 606 during the second service period 620. During this duration of time 606 where the legacy STA avoids channel access, the LL STA may contend for the channel.

In some embodiments, the defer signal may be transmitted in a known time gap. As described herein, a known time gap may refer to a gap that one or more STAs (e.g., all STAs) are aware of. Here a known time gap can be one or more of the time gaps as listed in Table 2.

Table 2 provides know time gaps that can be used for transmission of defer signal in accordance with an embodiment.

TABLE 2

| Time gap | Description |
|---|---|
| Interframe | The defer signal can be transmitted in an interframe spacing gap. e.g., in a |
| spacing gap | Distributed Coordination Function (DCF) Interframe Spacing (DIFS) |
| | period, reduced inter-frame space (RISF), short inter-frame space (SISF), |
| | or in a newly defined interframe spacing period. |

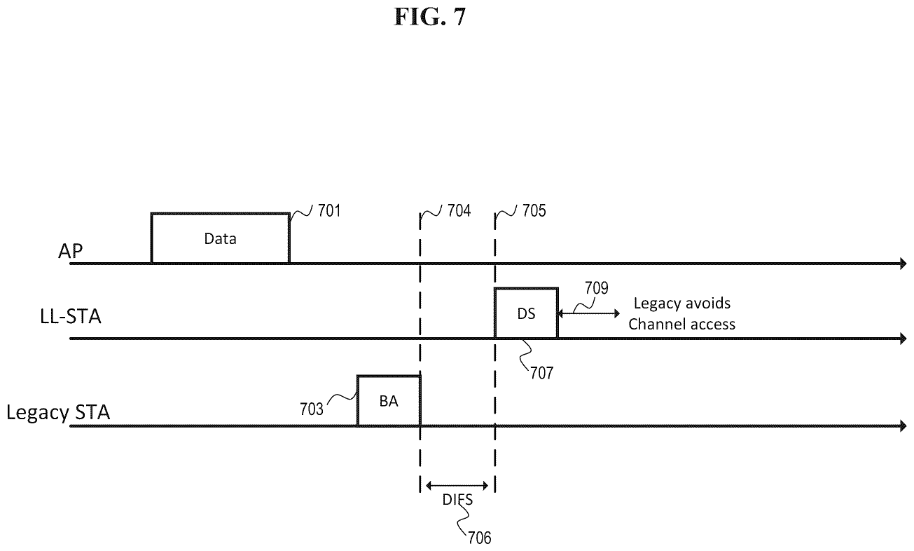

FIG. 7 illustrates using an interframe spacing boundary for defer signal transmission in accordance with an embodiment. An interframe space (IFS) may be a waiting period between transmission of frames. In particular, IFS may be the time period between a completion of a transmission of a last frame and starting transmission of next frame apart from In particular, FIG. 7 illustrates communication among an AP, a LL STA, and a legacy STA. FIG. 7 also illustrates a DIFS time gap 706 that includes a DIFS start time boundary 704 and a DIFS end time boundary 705. The DIFS time gap 706 is a time interval that a STA should wait before it transmits a frame. As illustrated, the AP transmits data 701 to the legacy STA and the legacy STA transmits a block acknowledgment (BA) 703 to the AP. After the BA 703, there is a DIFS time interval 706. At the DIFS end time boundary 705, the LL STA transmits a defer signal 707. The DIFS time interval 706 is known to the AP, the LL STA, and the legacy STA. Accordingly, after the LL STA transmits the defer signal 707, the legacy STA avoids channel access for a duration of time 709. During this time period 709, the LL STA may contend for the channel.

In some embodiments, the defer signal can be transmitted using a request and response procedure. In some embodiments, a request message can be transmitted by one STA to another STA to request the other STA to transmit the defer signal. For example, one or more LL STAs can transmit the request message to the AP to request the AP to transmit the defer signal.

The request message can include at least one or more of the information items as described in Table 3.

Table 3 provides a request message content in accordance with an embodiment.

TABLE 3

| Information | |
|---|---|
| item | Description |
| Request | An information item that can indicate that the message is a request for |
| indication | transmission of a defer signal. e.g., frame type, reason code, among |
| | others. |
| Time of defer | An information item that can indicate the time at which the defer signal |
| signal | can be transmitted. In some embodiments, this can be after an |
| transmission | interframe spacing following the transmission of the request message |
| | and an indication may not be made explicitly. |
| Medium time | An information item that can describe the time for which the STA can |
| | need the medium. This can enable the AP to set the defer duration |
| | accordingly. |

In some embodiments, a request message may have a common content that is unique for each basic service set (BSS). Thus, if multiple STAs transmit the request message at the same time, it may not result in a collision.

In some embodiments, request messages from multiple low-latency (LL) STAs can be transmitted at the same time. In some embodiments, different LL STAs can be assigned different resource units (RUs) for transmitting their request messages.

Upon receiving the request message from the STA, an AP receiving the request message can either transmit a response message to the STA confirming that the STA can transmit a defer signal or the AP can transmit the defer signal as the response to the request message.

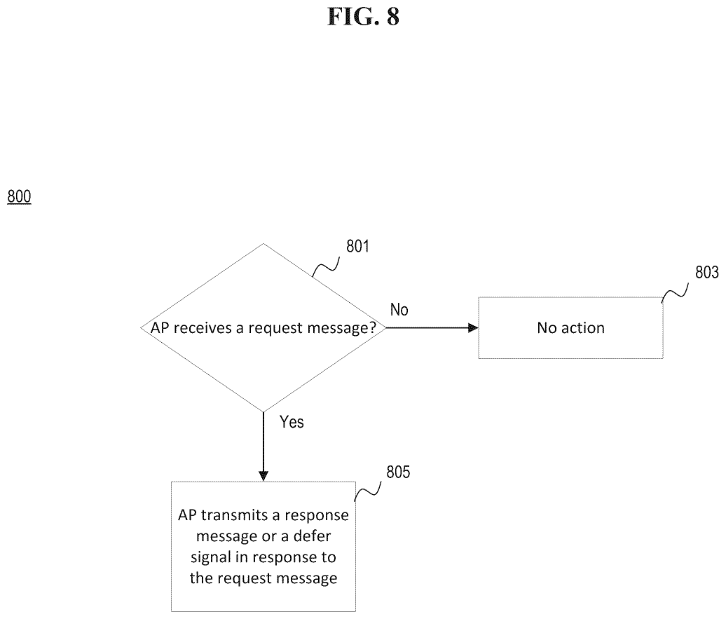

FIG. 8 illustrates a flow chart of an example process by an AP for defer signal transmission in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 8 illustrates operations performed in a AP, such as the AP illustrated in FIG. 3.

The process 800, in operation 801, the AP determines whether the AP receives a request message from a STA. If the AP determines that the AP does not receive a request message, the process proceeds to operation 803 and the AP performs no action. If the AP determines that the AP does receive a request message, the process proceeds to operation 805. In some embodiments, the request message may include a request indication that indicates that the message is a request for transmission of a defer signal. In some embodiments, the request message may include an information item that can indicate a time at which the defer signal should be transmitted. For example, the defer signal should be transmitted after an IFS following the transmission of the request message. In some embodiments, the request message may include an information item that provides duration information regarding a duration for which the STA may need the medium, and whereby the AP can set a defer duration accordingly.

In operation 805, the AP either transmits a response message to the STA or the AP transmits a defer signal in response to the request message. In some embodiments, the response message may provide a confirmation to the STA that the AP will transmit the defer signal. In some embodiments, the AP may transmit a defer signal without transmitting a response message to the STA. In some embodiments, the defer signal can be such that it can put legacy devices into a mode of operation where they may not perform channel access (e.g., extended interframe spacing (EIFS) state). In some embodiments, a defer signal can be designed such that it can cause the PHY-RXEND.indication primitive to include an error or a frame for which the frame check sequence (FCS) value is incorrect. After the AP transmits the defer signal on behalf of the STA, the STA may then contend for the channel.

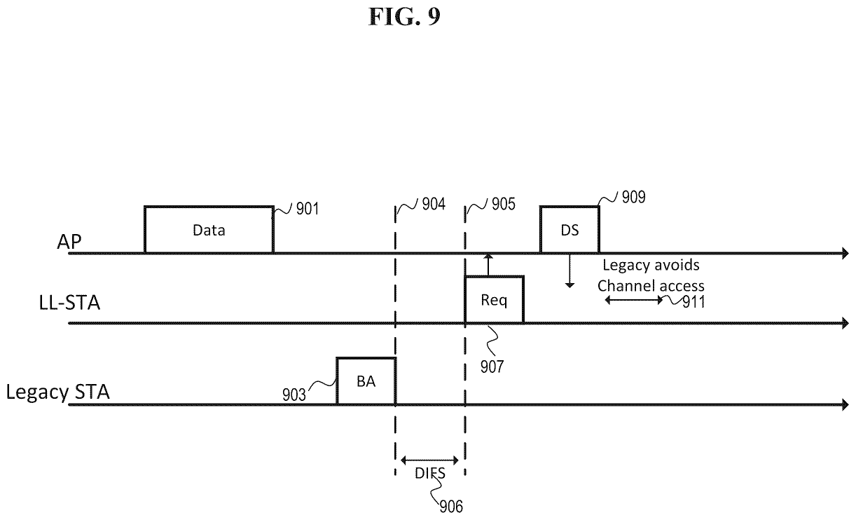

FIG. 9 illustrates an example of a defer signal transmission by an AP in accordance with an embodiment. In particular, FIG. 9 illustrates communication among an AP, a LL STA, and a legacy STA. Similar to FIG. 7, FIG. 9 illustrates a DIFS time gap 906 that includes a DIFS start time boundary 904 and a DIFS end time boundary 905. The DIFS time gap 706 may be a time interval that an STA should wait before it transmits a frame.

As illustrated, the AP transmits data 901 to the legacy STA and the legacy STA transmits a block acknowledgment (BA) 903 to the AP. After the BA 903, there is a DIFS time gap 906. After the DIFS end time boundary 905, the LL STA transmits a request message 907 to the AP. The request message 907 may include an information item that can indicate a time at which the defer signal should be transmitted. In some embodiments, the request message may include an information item that provides duration information regarding a duration for which the LL STA may need the medium, and whereby the AP can set a defer duration accordingly. The AP transmits a defer signal 909 in response to the request message 907 whereby the legacy STA avoids channel access for a duration of time 911. The defer signal can be such that it can put the legacy STA into a mode of operation where the legacy STA does not perform channel access (e.g., extended interframe spacing (EIFS) state). In some embodiments, the defer signal 909 can be designed such that it can cause the PHY-RXEND.indication primitive to include an error or a frame for which the frame check sequence (FCS) value is incorrect. After the AP transmits the defer signal 909 on behalf of the LL STA, the LL STA may then contend for the channel during the time duration 911 where the legacy STA avoids channel access.

In some embodiments, the AP can ignore a request for defer signal transmission from an STA and not transmit the defer signal. This can enable the AP to control when legacy devices are blocked from channel access.

In some embodiments, when the AP is sending a defer signal in response to a request signal, the low latency STAs that heard the request signal can ignore the defer signal and instead of avoiding channel access can contend to transmit their low latency frames.

In some embodiments, when the channel is found idle, a STA with low latency traffic can transmit a defer signal. The STA may not contend to access the channel. This can enable the STA to gain immediate channel access when necessary.

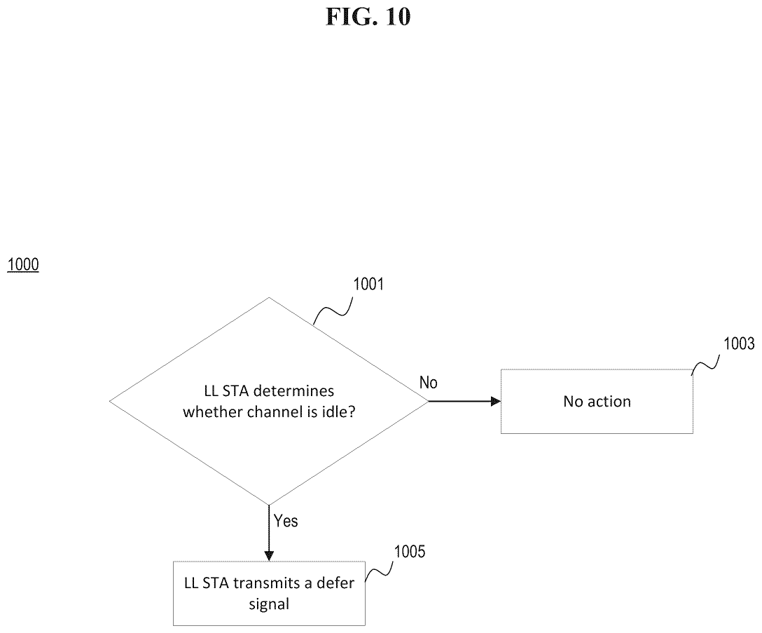

FIG. 10 illustrates a flow chart of an example process by a STA for transmitting a defer signal when a channel is idle in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 10 illustrates operations performed in a STA, such as the STA illustrated in FIG. 3.

The process 1000, in operation 1001, the low latency STA determines whether a channel is idle. If the LL STA determines that the channel is not idle, the process proceeds to operation 1003 and the STA performs no action. If the LL STA determines that the channel is idle, the process proceeds to operation 1005. In some embodiments, the LL STA may perform channel sensing whereby the STA listens for any ongoing transmissions on the channel to determine whether the channel is idle or busy. If the channel is idle may mean that no other STAs are transmitting on the channel.

In operation 1005, the LL STA transmits a defer signal. In some embodiments, the defer signal can be such that it can put the legacy STA into a mode of operation where the legacy STA does not perform channel access (e.g., extended interframe spacing (EIFS) state). In some embodiments, the defer signal can be designed such that it can cause the PHY-RXEND.indication primitive to include an error or a frame for which the frame check sequence (FCS) value is incorrect.

In some embodiments, there can be a predicted or periodic transmission of a defer signal. In some embodiments, the AP may know a quality of service (QOS) requirements of a STA and can transmit a defer signal at an optimal time to enable the STAs to gain channel access and transmit their frames to the AP.

In some embodiments, when a first STA has transmitted a defer signal, a second STA with low latency can ignore that defer signal and transmit its low latency frame if the second STA has a low latency frame to transmit. This can enable a low latency STA to benefit from the defer signal transmission of another STA.

In some embodiments, there may be defer periods that are introduced in advance. In some embodiments, the AP can introduce quiet periods in its beacons with an indication that these are meant for low latency transmission. Low latency STAs can ignore the quiet periods based on the AP's indication and can access the channel during those quiet periods.

In some embodiments, a STA that has low latency traffic can perform a channel access based defer signal transmission. In some embodiments, to perform channel access based defer signal transmission, the STA can make use of a prioritized EDCA parameter set such that the STA can obtain prioritized channel access for transmission of the defer signal.

In some embodiments, the defer signal can be such that it can put legacy devices into a mode of operation where they may not perform channel access (e.g., extended interframe spacing (EIFS) state). In some embodiments, a defer signal can be designed such that it can cause the PHY-RXEND.indication primitive to include an error or a frame for which the frame check sequence (FCS) value is incorrect. The defer signal can include at least one or more of the information items as shown in Table 4.

Table 4 includes information items that can be present in the defer signal in accordance with an embodiment.

TABLE 4

| Information | |
|---|---|
| item | Description |
| Transmitter/ | An information item that can indicate the address of the transmitter of the |
| receiver address | defer signal. This can also be a BSS identifier (e.g., BSSID) to indicate |
| | that the frame came from a particular BSS so that devices in other BSS |
| | can understand and respond accordingly. In some embodiments, the |
| | devices in a BSS can ignore the defer signal transmitted in another BSS. |
| | In some embodiments, if the AP responds to defer signal with another |
| | defer signal, then it can do so only when the transmitter address matches |
| | its BSSID. |
| PHY header | Physical (PHY) header or one or more portions of the PHY header. This |
| | can also indicate BSS color to enable a unique identification of the BSS. |
| Duration | An information item that can indicate the duration for which the |
| | transmission can occur. In some embodiments, this field can also be |
| | omitted to create a common defer signal design. |

In some embodiments, upon receiving a defer signal, all devices except the AP can avoid channel access (e.g., go into EIFS state).

In some embodiments, the defer signal's modulation can be used to control the duration for which legacy devices can avoid channel access (e.g., go into EIFS state). In some embodiments, there can be a defer signal which can cause the legacy devices to set their network allocation vector (NAV) timers instead of setting their state to EIFS state. In some embodiments, the defer signal can include at least one or more of the information items as indicated in Table 5.

Table 5 provides information items that can be present in the defer signal in accordance with an embodiment.

TABLE 5

| Information | |
|---|---|
| item | Description |
| Duration | An information item that can indicate the duration for which the channel |
| | access has to be avoided or NAV timer has to be set. |
| Transmitter/ | An information item that can indicate the address of the transmitter of the |
| Receiver address | defer signal. This can also be a BSS identifier (e.g., BSSID) to indicate |
| | that the frame came from a particular BSS so that STAs in other BSS can |
| | understand and respond accordingly. In some embodiments, the STAs in |
| | a BSS can ignore the defer signal transmitted in another BSS. In some |
| | embodiments, if the AP responds to defer signal with another defer signal, |
| | then it can do so only when the transmitter address matches its BSSID. |

In some embodiments, one or more devices can ignore the defer signal. For example, an AP in a BSS can ignore the defer signal that is transmitted by one of its STAs, or Emergency Preparedness Communication Service (EPCS) authorized STAs can ignore the defer signal.

In some embodiments, there can be a membership to determine which STAs can ignore the defer signal. In some embodiments, the defer signal can be transmitted by a STA that can need the assistance for its own low latency traffic. In some embodiments, a defer signal can also be transmitted by another STA on behalf of a STA.

In some embodiments, a STA can transmit a defer signal on behalf of another STA. For example, a peer-to-peer (P2P) group owner can transmit a defer signal on behalf of other devices in the group, or a P2P device can transmit a defer signal on behalf of a peer.

In some embodiments, the AP can send the defer signal to assist its associated low latency STAs. The AP can transmit a defer signal with transmitter or receiver address set to the BSSID. This can enable neighboring BSS to ignore the defer signal. In some embodiments, the BSS color field can also be used to identify the signal as coming from a neighboring BSS and ignore it. In some embodiments, the AP can transmit the defer signal at a known time boundary or without any contention when channel is idle. Upon receiving the defer signal, the legacy STAs can defer or enter into a mode that prevents them from accessing the channel (e.g. EIFS state). Low latency STAs can contend for channel access.

In some embodiments, a P2P group owner, leader, or representative device can transmit a defer signal for its own P2P transmission or for P2P transmission of one or more devices in its P2P group. Upon receiving the defer signal, legacy devices which can also be from an AP's BSS can avoid channel access and the devices in the P2P group can get advantage in channel access. There can be a negotiation between the AP and the P2P devices about whether a device can transmit such a defer signal or not for the purpose of P2P communication. If the AP authorizes the device to transmit the defer signal, then the device can transmit the signal.

In some embodiments, a mobile AP can transmit a defer signal to give the devices in its own BSS an advantage in channel access over the devices in an infra AP's BSS. The mobile AP can perform a negotiation with the infra AP about whether it can transmit the defer signal or not and transmit the defer signal if authorized.

Embodiments in accordance with this disclosure provide an ability for STAs with low latency traffic to transmit defer signals to preempt legacy devices from contending for channel access, and thus allowing the LL STAs to quickly obtain channel access to transmit LL frames, thereby improving wireless communications and performance of low latency applications.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
determine that the STA has low-latency traffic to be transmitted;
transmit a defer signal to block one or more STAs from contending for a channel for a period of time;
contend for the channel and obtain access to the channel during the period of time; and
transmit, to an access point (AP), the low-latency traffic via the channel.

2. The STA of claim 1, wherein the defer signal is transmitted at a pre-determined time that is associated with at least one of an interframe spacing (IFS) start time boundary, an IFS end time boundary, a service period start time, a service period end time, or a time boundary marked by periodic frames.

3. The STA of claim 1, wherein the processor is further configured to:
determine that the channel is idle; and
transmit another defer signal based on the determination that the channel is idle.

4. The STA of claim 1, wherein the processor is further configured to use a prioritized enhanced distributed channel access (EDCA) parameter set that prioritizes transmission of the low-latency traffic.

5. The STA of claim 1, wherein the defer signal causes the one or more legacy STAS to:
abstain from contending the channel access for a period of time;
enter an extended interframe space (EIFS) state for the period of time; or
update a network allocation vector (NAV) timer for the period of time.

6. The STA of claim 1, wherein the defer signal is a frame transmitted to the one or more STAs for which a frame check sequence value of the frame is incorrect.

7. The STA of claim 1, wherein defer signal is a frame and a modulation of the frame determines a duration for which the one or more STAs are blocked from contending for the channel.

8. The STA of claim 1, wherein the processor is further configured to transmit, during a pre-determined interframe spacing gap, another defer signal.

9. An access point (AP) in a wireless network, the AP comprising:
a memory; and
a processor coupled to the memory, the processor configured to:
determine that a station (STA) has low-latency traffic to be transmitted;
transmit a defer signal to block one or more STAs from contending for a channel for a period of time; and
receive, from the STA, the low-latency traffic via the channel.

10. The AP of claim 9, wherein the defer signal is transmitted at a pre-determined that time is associated with at least one of an interframe spacing (IFS) start time boundary, an IFS end time boundary, a service period start time, a service period end time, or a time boundary marked by periodic frames.

11. The AP of claim 9, wherein the processor is further configured to:
determine that the channel is idle; and
transmit another defer signal based on the determination that the channel is idle.

12. The AP of claim 9, wherein the defer signal causes the one or more STAS to:
abstain from contending the channel access for a period of time;
enter an extended interframe space (EIFS) state for the period of time; or
update a network allocation vector (NAV) timer for the period of time.

13. The AP of claim 9, wherein the defer signal is a frame transmitted to the one or more STAs for which a frame check sequence value of the frame is incorrect.

14. The AP of claim 9, wherein the defer signal is a frame and a modulation of the frame determines a duration for which the one or more STAs are blocked from contending for the channel.

15. A computer-implemented method for wireless communication by a station (STA) in a wireless network, comprising:
determining that the STA has low-latency traffic to be transmitted;
transmitting a defer signal to block one or more STAs from contending for a channel for a period of time;
contending for the channel and obtain access to the channel during the period of time; and
transmitting, to an access point (AP), the low-latency traffic via the channel.

16. The computer-implemented method of claim 15, wherein the defer signal is transmitted at a pre-determined time that is associated with at least one of an interframe spacing (IFS) start time boundary, an IFS end time boundary, a service period start time, a service period end time, or a time boundary marked by periodic frames.

17. The computer-implemented method of claim 15, further comprising:
determining that the channel is idle; and
transmitting another defer signal based on the determination that the channel is idle.

18. The computer-implemented method of claim 15, further comprising using a prioritized enhanced distributed channel access (EDCA) parameter set that prioritizes transmission of the low-latency traffic.

19. The computer-implemented method of claim 15, wherein the defer signal causes the one or more STAS to:
abstain from contending the channel access for a period of time;
enter an extended interframe space (EIFS) state for the period of time; or
update a network allocation vector (NAV) timer for the period of time.

20. The computer-implemented method of claim 15, wherein the defer signal is a frame transmitted to the one or more STAs for which a frame check sequence value of the frame is incorrect.
